(19) United States
(12) Patent Application Publication
(10) Pub. No.: US 2008/0268789 A1
(43) Pub. Date: Oct. 30, 2008

(54) Method and System for Determining the Amplitude and/or Phase of the Output Signal of a Transmission Link as a Function of the Amplitude of the Input Signal

(75) Inventors: Ralf Plaumann, Forstern (DE); Rolf Lorenzen, Unterhaching (DE)

Correspondence Address: LEWIS, RICE & FINGERSH, LC;ATTN: BOX IP DEPT., 500 NORTH BROADWAY, SUITE 2000, ST LOUIS, MO, 63102, US

(73) Assignee: Rohde & Schwarz GmbH & Co. KG

(21) Appl. No.: 11/720,043

(22) PCT Filed: Nov. 15, 2005
(86) PCT No.: PCT/EP2005/012264

§ 371 Date: Mar. 19, 2008

(30) Foreign Application Priority Data
Nov. 26, 2004 (DE) 10 2004 057 189.9
Jan. 17, 2005 (DE) 10 2005 002 207.3

(51) Int. Cl. H04B 17/00

(52) U.S. Cl. 455/67.14

(57) ABSTRACT

A method and system for determining the amplitude and/or phase of the output signal of a transmission link according to the amplitude of the input signal (AM-AM and AM-PM characteristics). The response signal (e(t)) emanating from a test signal as a result of amplitudes and/or phase distortion in the transmission link is determined with respect to the associated amplitude characteristics (|e(t)|) and/or associated phase characteristics (φ_{E}(t)) according to the test signal (s(t)). Only the amplitude characteristic (|e(t)|) and/or phase characteristic (φ_{E}(t)) of the response signal (e(t)) are measured.

The invention relates to a method and a system for determining the amplitude and/or phase of the output signal of a transmission link as a function of the amplitude of the input signal (AM-AM and AM-PM characteristic line).

Telecommunications transmission links, for example amplifiers in the receiving or transmitting unit of mobile radio equipment, have a non-linear transmission behaviour. This non-linear transmission behaviour leads to undesired amplitude and phase distortions of the signal to be amplified. In order to compensate for these undesired distortion effects, as is known an equalising network is connected in series to the non-linear transmission link, the characteristic line of said equalising network being expressed ideally inversely to the non-linear transmission characteristic line of the transmission link.

For the design of the characteristic line of the equalising network, the amplitude and phase of the output signal of the transmission link as a function of the amplitude of the input signal (AM-AM and AM-PM characteristic line) is consequently required. Determination of the amplitude characteristic line of the transmission link is produced from the functional correlation of the amplitude or of the power of the signal at the output of the transmission link as a function of the amplitude or of the power of the corresponding signal at the input of the transmission link in a defined amplitude or power region of the signal at the input of the transmission link. The phase characteristic line of the transmission link in turn represents the functional correlation of the phase change of the signal between output and input of the transmission link as a function of the amplitude or power of the signal at the input of the transmission link in a defined amplitude or power region of the signal at the input of the transmission link.

In WO 99/05784 A1, a method and a device for measuring the amplitude and phase distortion of a high frequency power amplifier is described. The signal at the input and at the output of the high frequency power amplifier respectively is hereby measured via synchronous demodulators. For representation of the amplitude characteristic line, the ratio of the input amplitude to the output amplitude or output power is determined, whereas, for representation of the phase characteristic line, the phase value associated with the respective amplitude or power of the signal at the input is determined from the inphase- and quadrature component of the output signal. By specifying a specific signal course at the input of the high frequency power amplifier by means of a signal generator, the entire course of the amplitude and phase characteristic line is determined. The synchronisation between the signal at the input and at the output of the high frequency power amplifier is effected via a reference carrier signal between the individual synchronous demodulators.

When calibrating power amplifiers in receiving and/or transmitting units of mobile radio equipment, the procedure, described in WO 99/05784 A1, for measuring two signals—at the input and at the output of the power amplifier—and for the additionally required synchronisation of the two signals is too time-consuming and simultaneously operationally complex.

The object therefore underlying the invention is to produce a method and a system for determining the amplitude and/or phase of the output signal of a transmission link as a function of the amplitude of the input signal which is optimised with respect to minimum process time and maximum process reliability.

The object of the invention is achieved by a method for determining the amplitude and/or phase of the output signal of a transmission link as a function of the amplitude of the input signal, having the features according to claim 1, and by a system for determining the amplitude and/or phase of the output signal of a transmission link as a function of the amplitude of the input signal, having the features according to claim 17. Advantageous developments of the invention are cited in the dependent claims.

In the case of the method according to the invention and in the case of the system according to the invention for determining the amplitude and/or phase of the output signal of a transmission link as a function of the amplitude of the input signal, according to the invention only the signal at the output of the transmission link is measured. The signal, which is impressed at the input of the transmission link and no longer measured, must consequently be known and, with respect to determination of the amplitude and phase characteristic line of the transmission link, should be distorted solely by the transmission link with respect to its amplitude and phase. The first condition is achieved in that a known test signal is prescribed by the user via a unit for superordinate operating control of a transmitting unit for producing the signal at the input of the transmission link. The second condition is fulfilled by a metrological and circuit-technology arrangement which guarantees the avoidance of additional amplitude and phase distortions in the signal path.

The omitted time, frequency and phase synchronisation between the test signal at the input of the transmission link and the response signal at the output of the transmission link, which response signal results from the test signal by amplitude and phase distortion in the transmission link, is preferably obtained from the response signal via estimation of the time, frequency and phase offset. For this purpose, the test signal and hence the response signal which is dependent upon the test signal is sub-divided into a first and a second signal portion.

In the first signal portion I, the determination of the time offset between test and response signal is effected and, building thereon, the determination of the starting time of the second signal portion II. In addition, the frequency offset of the carrier signal between input and output of the transmission link is determined in the signal portion I.

In the second signal portion II, the actual determination of the amplitude and phase characteristic of the transmission link is effected on the basis of the reference values determined in the signal portion I:
starting time of the signal portion II,
phase of the response signal at the starting time in relation to a reference phase and
frequency offset of the carrier signal between input and output of the transmission link.

For the first signal portion I, also with respect to determination of the amplitude and phase characteristic line of a power amplifier in the receiving and transmitting unit of mobile radio equipment, for example a GSM burst signal is used. Via a modulation analysis which belongs to the state of the art, the time and frequency offset is estimated on the basis of a test symbol sequence of the GSM burst signal.

The second signal portion II can have any arbitrary signal course. With respect to a time-efficient calibration of the total level range, a ramp-like amplitude course is however advantageous which, beginning with the GSM burst signal level as maximum amplitude level to be calibrated, drops to the minimum amplitude level to be calibrated. The phase course should be designed to be constant for the sake of simplicity.

In order to minimise the noise proportion when determining the amplitude and phase characteristic line of the transmission link, the transmission link is supplied not only once with a test signal with upper signal expression, but it can be excited multiple times with an identical test signal and the response signal course which is measured respectively at the output of the transmission link can be supplied for averaging. With respect to a coherent averaging, the phase of the response signal which is determined respectively in the signal portion I is referenced at the starting time of the signal portion II relative to an established reference phase and the individual response signals are averaged in phase synchronisation relative to each other by means of referencing relative to the reference phase.

From the amplitude and phase course of the response signal, averaged respectively in the measuring appliance, and from the previously established amplitude and phase course of the test signal, the determining amplitude and phase characteristic for the transmission link is preferably determined in a unit for superordinate operating control.

One embodiment of the method according to the invention for measuring the amplitude and phase characteristic of a transmission link and of the system according to the invention for measuring the amplitude and phase characteristic of a transmission link is explained subsequently in more detail with reference to the drawing. There are shown in the drawing:

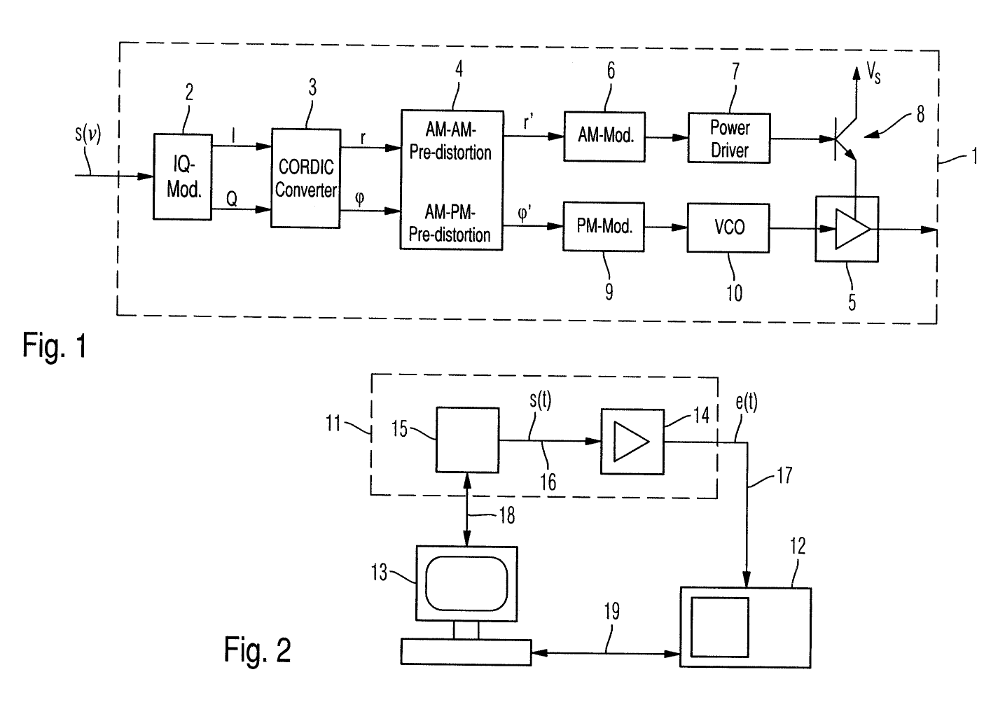

FIG. 1 a block diagram of a polar modulator to be calibrated for mobile radio equipment,

FIG. 2 a block diagram of a system according to the invention for measuring the amplitude and phase characteristic of a transmission link,

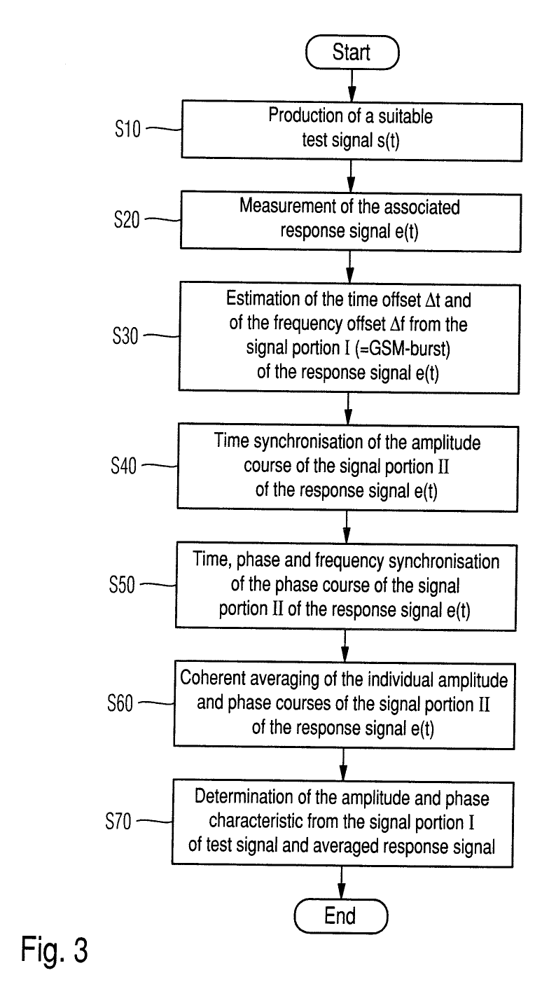

FIG. 3 a flow diagram of a method according to the invention for measuring the amplitude and phase characteristic of a transmission link,

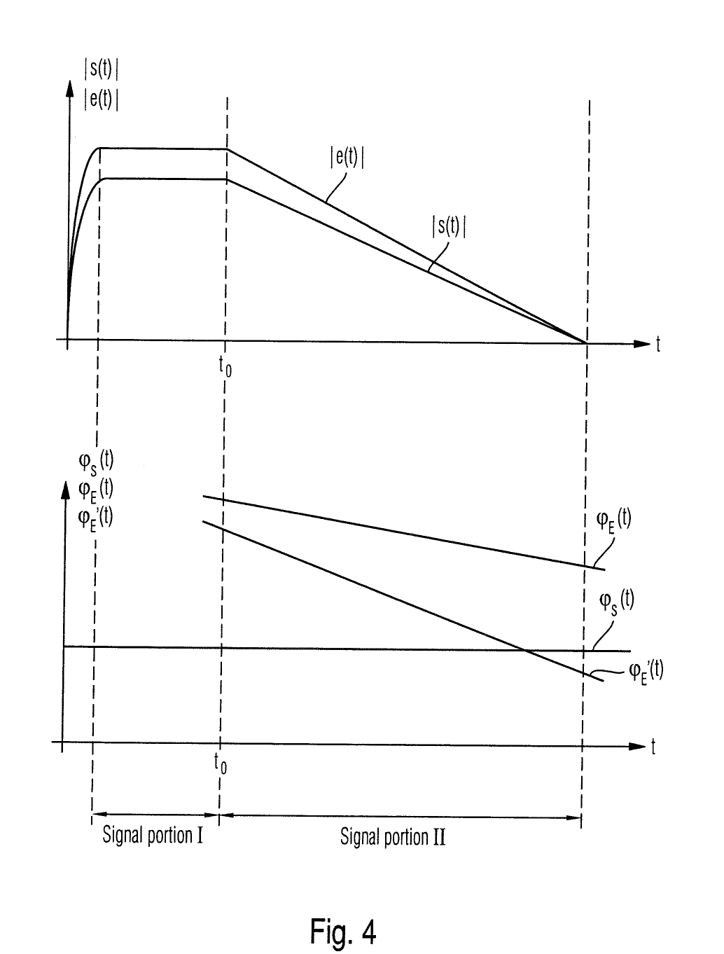

FIG. 4 a time diagram of the amplitude and phase course of the test and response signal and

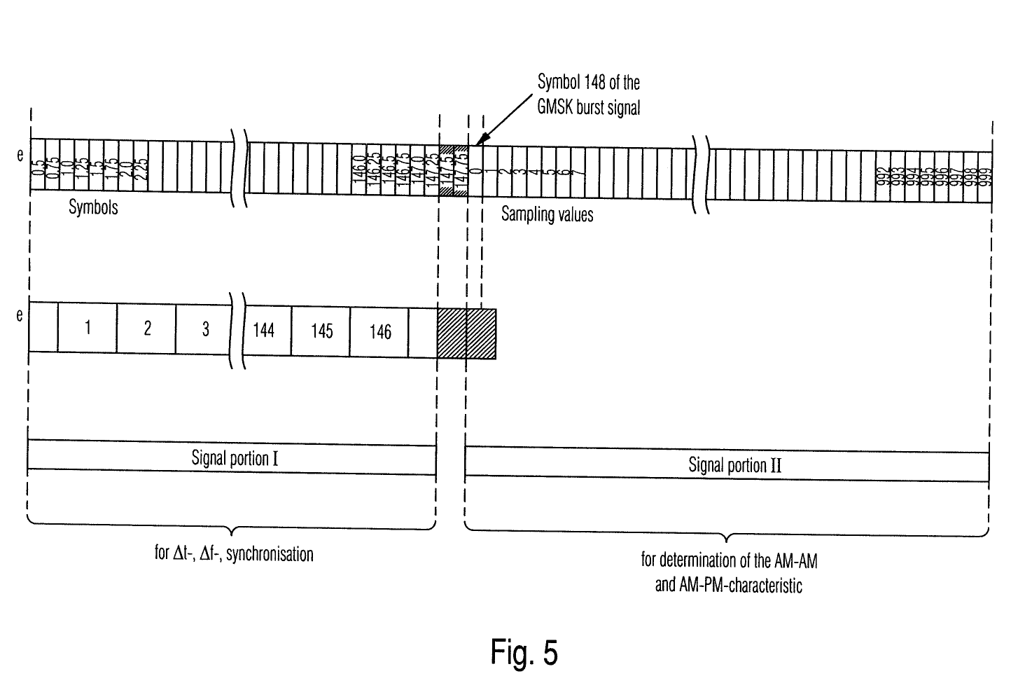

FIG. 5 a symbol sequence structure of a GSM-based test signal.

Before the system according to the invention and the method according to the invention for determining the amplitude and phase characteristic of a general transmission link is described with reference to FIG. 2 and FIG. 3, firstly with reference to FIG. 1, the structure and mode of operation of a polar modulator for mobile radio equipment is presented, the calibration of which counts as preferred application case of the method according to the invention and system according to the invention for determining the amplitude and phase characteristic line of a transmission link.

The polar modulator 1 is supplied, from a signal source which is not represented in FIG. 1, with a symbol sequence s(ν) to be transmitted. An IQ modulator 2 produces, from the symbol sequence s(ν), with the help of a carrier signal, the inphase and quadrature component I and Q of a quadrature signal to be transmitted by the mobile radio equipment. Conversion of the inphase and quadrature component I and Q of the quadrature signal is effected via a CORDIC converter 3 into amplitude and phase components r and φ of the signal to be transmitted which correspond thereto.

In a subsequent pre-distortion unit 4, a separate pre-distortion of the amplitude component r and of the phase component φ is effected. Due to the pre-distortion, an amplitude and phase distortion, which is produced in the subsequent power amplifier 5, of the signal to be transmitted is compensated for and hence a signal to be transmitted is produced in the polar modulator 1 which ideally has no amplitude and phase distortion.

The pre-distorted amplitude component r′ is subsequently converted in an amplitude modulator 6 essentially via a multiplying digital-analogue converter into the level region required for actuation of a subsequent power driver 7. The power driver 7 actuates a power transistor 8 which is supplied from a voltage source Vₛ and serves as external power end stage of the power amplifier 5.

Parallel to the amplitude modulation path, the pre-distorted phase component φ′ is supplied to a phase modulator 9 in a phase modulation path. The phase modulator 9 produces a signal from the phase component φ′, which signal corresponds to the frequency of the phase component φ′ which rotates over time and serves as frequency reference value for a subsequent voltage-controlled frequency oscillator (VCO) 10. The frequency signal produced by the voltage-controlled frequency oscillator 10 is supplied to the power amplifier 5 and amplified with respect to its amplitude in the power transistor 8 serving as power end stage and is conveyed further at the output of the power amplifier 5 to the antenna of the mobile radio equipment.

For the pre-distortion of the amplitude component r and of the phase component φ of the signal to be transmitted, in the pre-distortion unit 4 the amplitude pre-distortion characteristic line (AM-AM pre-distortion characteristic line) and the phase pre-distortion characteristic line (AM-PM pre-distortion characteristic line) should be determined, which, with ideal pre-distortion, is respectively inverse relative to the amplitude distortion characteristic line (AM-AM distortion characteristic line) and phase distortion characteristic line (AM-PM distortion characteristic line) of the power amplifier 5. Hence for a distortion-free operation of the polar modulator 1 of the mobile radio equipment, determination of the amplitude and phase characteristic of the power amplifier 5 should be determined within the framework of a calibration process of the mobile radio equipment.

Starting from a power amplifier 5 of a polar modulator 1 for mobile radio equipment according to FIG. 1, a system according to the invention for determining the amplitude and phase characteristic line of a general transmission link is presented subsequently in FIG. 2.

The system according to the invention comprises a measuring object to be calibrated (device under test=DUT) 11, which corresponds to the polar modulator 1 of the mobile radio equipment in FIG. 1, a measuring appliance 12 and a unit for superordinate operating control 13 which is produced for example by a personal computer. The measuring object (DUT) 11 to be calibrated in turn comprises a transmission link 14, which corresponds to the power amplifier 5 of the polar modulator 1 in FIG. 1, having a generally non-linear amplitude and phase characteristic line.

The transmission link 14 is supplied, from a transmitting unit 15 which corresponds in total to the functional units 2, 3, 4, 6, 7, 8, 9 and 10 of the polar modulator 1 in FIG. 1, via the unidirectional connection line 16 with a test signal s(t), which comprises an amplitude component |s(t)| and a phase component φₛ(t), and delivers a response signal e(t) which is distorted corresponding to its amplitude and phase characteristic line and comprises an amplitude component |e(t)| and a phase component φ_{E}(t) via the unidirectional connection line 17 to the measuring appliance 12. The unit for superordinate operating control 13 communicates via the bidirectional connection line 18 with the transmitting unit 15 and via the bidirectional connection line 19 with the measuring appliance 12.

The preferred method according to the invention for determining the AM-AM and the AM-PM behaviour of a transmission link 14 according to FIG. 3 begins, in method step S10, with the production of a previously established test signal s(t) by means of the transmitting unit 15. The test signal s(t) is sub-divided in principle according to FIG. 4 into a first signal portion I and into a second signal portion II.

A burst signal is used in the first signal portion I, in the case of calibration of mobile radio equipment according to the modulation standard used, for example a GMSK-, EDGE-, AMPS-, ANSI-136- or broadband-CDMA-burst signal. If for example a GMSK burst signal is used then this comprises, according to FIG. 5, a symbol sequence of in total 148 symbols, as standard, which are transmitted at a specific standard established sampling rate fₛ. Within this symbol sequence of in total 148 symbols, a modulation analysis for time, frequency and phase synchronisation of the receiver with the transmitter is implemented by the GSM receiver.

In the second signal portion II, the actual determination of the amplitude and phase characteristic of the transmission link 14 is effected. An arbitrary amplitude course |s(t)| and phase course φₛ(t) of the test signal s(t) can hereby be established. In the amplitude course |s(t)|, all the signal level values of the entire input signal range of the transmission link 14 should occur at least once. In order to minimise the calibration time of the measuring object 11 to be calibrated, a ramp-like amplitude course |s(t)| is preferred in the second signal portion II of the test signal s(t), the starting amplitude value of which is usefully close to the amplitude value of the GSM burst symbol sequence and which drops in a ramp-shape down to the minimum amplitude value of the input signal range of the transmission link 14. The phase course φₛ(t) should conveniently have a constant course.

The test signal s(t) is distorted as a result of the amplitude and phase characteristic line of the transmission link 14. The response signal e(t), which results from the test signal s(t) due to amplitude and phase distortion, at the output of the transmission link 14 is measured, in method step S20, in the first step with respect to the course of its inphase and quadrature component by the measuring appliance 12, from which, in the second step, the amplitude course |e(t)| and phase course φ_{E}(t) is determined.

In the subsequent method step S30, the above-mentioned modulation analysis of the GSM burst signal used in the case of a calibration of mobile radio equipment is effected by the measuring appliance 12 in the first signal portion I of the measured response signal e(t). Determination of the time offset Δt between test signal s(t) and response signal e(t), of the frequency offset Δf of the carrier between input and output of the transmission link 14 and of the phase offset between test signal s(t) and response signal e(t) is effected with known estimation methods which are based essentially on the method of the minimum error squares.

In the next method step S40, the time synchronisation of the amplitude course |e(t)| of the response signal e(t) is effected by the measuring appliance 12 in the second signal portion II by determining the starting time t₀ of the second signal portion II. The starting time t₀ of the second signal portion II of the response signal e(t) is produced from the starting or end time, to be measured, of the training sequence (TSC) and of the known number of bits between the starting or ending time of the training sequence (TSC) and the starting time t₀.

The subsequent method step S50 contains the time, phase and frequency synchronisation of the phase course φ_{E}(t) of the response signal e(t) in the second signal portion II. The time synchronisation of the phase course φ_{E}(t) with determination of the starting time t₀ of the second signal portion II corresponds to the time synchronisation of the amplitude course |e(t)| in method step S40.

During the phase synchronisation, the phase of the response signal e(t) is synchronised with the phase of the test signal s(t) at the starting time to of the second signal portion II. Since the phase of the response signal e(t) at the starting time t₀ of the second signal portion II can vary slightly during each measurement as a result of the AM-PM distortion caused by the unknown symbol sequence in the signal portion I at the same time as a result of an unforeseeable phase distortion caused by the noise of the test signal s(t) and of a modulation-dependent phase error in the first signal portion I, the phase φ_{E}(t₀) of the response signal e(t) which is measured at the start t₀ of the second signal portion II and also the total measured phase course φ_{E}(t) of the response signal e(t) should be referenced in relation to a previously established reference phase φ_{ERef}(t₀) at the starting time t₀ of the second signal portion II. Via a phase shift, implemented in the subsequent method step S60, of the phase course φ_{E}(t) of the response signal e(t) at the level of the phase difference between the phase φ_{E}(t₀) of the response signal e(t) and of the reference phase φ_{ERef}(t₀), a phase synchronisation between a plurality of response signals eᵢ(t) which are measured one after the other, can be achieved in the second signal portion II.

Finally, the phase course φ_{E}(t) of the response signal e(t), which is referenced relative to the reference phase φ_{ERef}(t₀), in the second signal portion II with respect to a frequency offset Δf of the carrier identified in method step S40 should be compensated for within the framework of the frequency synchronisation. The phase course φ_{E}′(t) of the response signal e(t), which has not yet been compensated for by the frequency offset Δf of the carrier between input and output of the transmission link 14, in the signal portion II would, according to FIG. 4, lead to an additional undesired phase drift. The phase course φ_{E}(t) of the response signal e(t), which is compensated for by the frequency offset Δf of the carrier between input and output of the transmission link 14 and which hence is phase drift-free, in the signal portion II is likewise illustrated in FIG. 4.

In method step S60, finally the coherent averaging of the course, measured with multiple supply of the transmission link 14 with a random test signal s(t) respectively by the measuring appliance 12, of the inphase and quadrature component I_{Ei}(t) and Q_{Ei}(t) of the response signal eᵢ(t) is effected before, from the averaged course of the inphase and quadrature component of the response signal e(t), the amplitude and phase course |e(t)| and φ_{E}(t) of the response signal e(t) is determined in signal portion II. Due to the averaging, the signal-to-noise spacing of the inphase and quadrature component course I_{E}(t) and Q_{E}(t) and hence of the amplitude and phase course |e(t)| and φ_{E}(t) of the response signal e(t) is minimised in signal portion II. The averaged inphase component course I_{E}(t) of the response signal e(t) in signal portion II is produced from the inphase component course I_{Ei}(t) of the response signal eᵢ(t) which are respectively phase-synchronised with each other. The averaged quadrature component course Q_{E}(t) of the response signal e(t) in signal portion II is produced from the quadrature component course Q_{Ei}(t) of the response signal eᵢ(t) which are respectively phase-synchronised with each other.

Finally in method step S70, determination of the amplitude and phase characteristic line of the transmission link 14 is effected by the unit for superordinate operating control 13 from the previously established amplitude course |s(t)| and phase course φₛ(t) of the test signal s(t) in signal portion II and is communicated to the transmitting unit 15 via the connection line 18 and from the averaged amplitude course |e(t)| and phase course φ_{E}(t) of the response signal e(t) in signal portion II and is communicated to the unit for superordinate operating control 13 by the measuring appliance 12 via the connection line 19. For determination of the AM-AM characteristic of the transmission link, the measured amplitude course |e(t)| of the response signal e(t) is represented as a function of the produced amplitude course |s(t)| of the test signal s(t). For determination of the AM-PM characteristic of the transmission link, the phase difference course between the averaged phase course φ_{E}(t) of the response signal e(t) and the produced phase course φ_{S}(t) of the test signal s(t) is represented as a function of the produced amplitude course |s(t)| of the test signal s(t).

The invention is not restricted to the illustrated embodiment. In particular the measurement of other telecommunications transmission links, e.g. filters, mixers etc., and other transmission signals according to other modulation methods and standards are covered by the invention.

1-16. (canceled)

17. A method for determining the amplitude or the phase of an output signal of a transmission link as a function of the amplitude of an input signal; the method comprising
determining the amplitude course of a response signal which results from a test signal by amplitude distortion or phase distortion in said transmission link as a function of the amplitude course of said test signal and of the phase difference course between a phase course of said response signal and a phase course of said test signal as a function of the amplitude course of said test signal; and
measuring solely said amplitude course or said phase course of said response signal, in that a unit for superordinate operating control communicates said test signal to said transmitting unit for generating said test signal at the input of said transmission link; and
communicating said response signal, which is measured at the output of said transmission link, to said unit for superordinate operating control by a measuring appliance, for determination of amplitude or the phase of an output signal of a transmission link.

18. The method of claim 17 wherein said amplitude course and said phase course of said test signal are known.

19. The method of claim 17 wherein the synchronization of said measured response signal with said test signal contains a time, frequency and phase synchronization.

20. The method of claim 17 wherein an estimation of a time offset, of a frequency offset and of a phase offset between said test signal and said response signal in a first signal portion of said test signal or of said response signal precedes the synchronization of said test signal with said response signal.

21. The method of claim 20 wherein for the estimation in said first signal portion of said test signal or said response signal, a defined synchronizing signal is used.

22. The method of claim 21 wherein said defining synchronizing signal is a burst signal according to the GSM standard.

23. The method of claim 21 wherein the estimation is effected via a modulation analysis of said burst signal.

24. The method of claim 20 wherein in a second signal portion temporally subsequent to said first signal portion, the synchronization of said measured response signal with said test signal and the determination of said amplitude or said phase of said output signal of said transmission link is effected.

25. The method of claim 24 wherein said time synchronization of said test signal with said response signal includes determination of a starting time of said second signal portion of said response signal.

26. The method of claim 24 wherein the phase synchronization of said test signal with said response signal includes determination of a phase of said phase course of said response signal with said starting time of said second signal portion which is referenced relative to a previously established reference phase.

27. The method of claim 24 wherein the frequency synchronization between said test signal and said response signal includes compensation of the phase drift caused by said frequency offset between said test signal and said response signal in a phase course in said second signal portion of said response signal.

28. The method of claim 24 wherein said phase synchronization includes in addition averaging of a plurality of response signals which respectively result from supply of said transmission link with respectively one random test signal.

29. The method of claim 28 wherein the averaging is a coherent averaging in which the individual measured response signals are averaged phase-synchronously with each other.

30. The method of claim 29 wherein during the phase-synchronous averaging after a phase shift of the phase courses of said response signal at the level of the phase difference between the phase of said response signal relative to said starting time of said second signal portion and of the previously established said reference phase, the individual measured response signals are averaged.

31. A system for determining the amplitude or phase of an output signal of a transmission link as a function of the amplitude of an input signal; the system comprising
a series connection to said transmitting unit for generating a test signal at the input of said transmission link;
said transmission link, which is supplied with a test signal generated by a transmitting unit;
a measuring appliance for measuring solely a response signal resulting from said test signal by amplitude or phase distortion in said transmission link; and
for communication of said response signal to a unit for superordinate operating control, said unit for superordinate operating control communicating said test signal to said transmitting unit and determining said amplitude or said phase of said output signal of said transmission link as a function of said amplitude of said input signal.

32. The system of claim 31 wherein said transmission link is a power amplifier which is integrated in a polar modulator for mobile radio equipment.

33. A method for determining the amplitude and the phase of an output signal of a transmission link as a function of the amplitude of an input signal; the method comprising
determining the amplitude course of a response signal which results from a test signal by amplitude distortion and phase distortion in said transmission link as a function of the amplitude course of said test signal and of the phase difference course between a phase course of said response signal and a phase course of said test signal as a function of the amplitude course of said test signal; and
measuring solely said amplitude course and said phase course of said response signal, in that a unit for superordinate operating control communicates said test signal to said transmitting unit for generating said test signal at the input of said transmission link; and
communicating said response signal, which is measured at the output of said transmission link, to said unit for superordinate operating control by a measuring appliance, for determination of amplitude and the phase of an output signal of a transmission link.

34. A system for determining the amplitude and phase of an output signal of a transmission link as a function of the amplitude of an input signal; the system comprising
a series connection to said transmitting unit for generating a test signal at the input of said transmission link;
said transmission link, which is supplied with a test signal generated by a transmitting unit;
a measuring appliance for measuring solely a response signal resulting from said test signal by amplitude and phase distortion in said transmission link; and
for communication of said response signal to a unit for superordinate operating control, said unit for superordinate operating control communicating said test signal to said transmitting unit and determining said amplitude and said phase of said output signal of said transmission link as a function of said amplitude of said input signal.
